(19) United States
(12) Patent Application Publication
(10) Pub. No.: US 2025/0298642 A1
(43) Pub. Date: Sep. 25, 2025

(54) COMMAND RECOMMENDATION SYSTEM AND USER INTERFACE ELEMENT GENERATOR, AND METHODS OF USE THEREOF

(71) Applicant: Meta Platforms Technologies, LLC, Menlo Park, CA (US)

(72) Inventors: Benjamin Lafreniere, Toronto (CA); Stephanie Santosa, Toronto (CA); Daniel John Wigdor, Toronto (CA); Michelle Li, Toronto (CA)

(21) Appl. No.: 19/084,571

(22) Filed: Mar. 19, 2025

Related U.S. Application Data
(60) Provisional application No. 63/567,355, filed on Mar. 19, 2024.

(51) Int. Cl. G06F 9/451; G06F 9/455

(52) U.S. Cl. CPC G06F 9/451; G06F 9/45512

(57) ABSTRACT

A method of generating recommended commands using artificial intelligence is described. The method includes, in response to a first user input, initiating a recommended command workflow. The recommended command workflow includes presenting a first recommended command that can be performed by the computing device and/or an application in communication with the computing device. The first recommended command is one of a plurality of recommended commands determined based on user data and/or device data. The recommended command workflow also includes, in response to a second user input selecting the first recommended command, causing performance of the first recommended command at the computing device and/or the application, and presenting a second recommended command that can be performed by the computing device and/or the application. The second recommended command is one of the plurality of recommended commands and augments the first recommended command.

### RELATED APPLICATION

This application claims priority to U.S. Provisional Application Ser. No. 63/567,355, filed Mar. 19, 2024, entitled “Command Recommendation System And User Interface Element Generator, And Methods Of Use Thereof,” which is incorporated herein by reference.

### TECHNICAL FIELD

This disclosure relates generally to command recommendations in user interfaces, including but not limited to techniques for determining recommended commands for a user and generating user interfaces for the recommended commands, and the generated user interfaces allowing the user to perform the recommended commands simultaneously or in sequence.

### BACKGROUND

Existing system and methods for recommending commands in a user interface use suggestive or predictive interfaces, which make automatic recommendations of actions a user may want to perform and present the recommended actions as suggestions in a user interface. The recommended actions are presented to the user such that they can accept or ignore the recommendations. The existing systems and methods present the recommended actions individually, which limits a user's ability to interact with or build on the recommended actions. Accordingly, there is a need for improved systems and methods that generate recommended actions in user interfaces that a user can interact with and/or build upon.

As such, there is a need to address one or more of the above-identified challenges. A brief summary of solutions to the issues noted above are described below.

### SUMMARY

The methods, systems, and devices described herein generate user interface elements for recommended actions based on predicted commands determined by a machine learning system. The disclosed methods, systems, and devices are configured to balance automation and control, and command and macro recommendations. The disclosed methods, systems, and devices recommend user interface commands for performing an action at an application based on predicted commands determined by artificial intelligence. The disclosed methods, systems, and devices generate user interface elements that improve overall task performance (e.g., user ability to perform a task or action within an application), and that enable users to quickly recognize and use high-utility aggregated commands. The graphical user interfaces generated by the disclosed methods, systems, and devices reduce user deliberation time in performing actions within an application.

Additionally, by generating recommended commands, the batter life of computing devices is extended due to reduced time spent by the user interacting with the computing device. Additionally, the generated recommended commands allow for the sequential and/or aggregated performance of commands, which can cause the computing device to perform different operations automatically without requiring the user access operations of the computing device or applications manually or individually. For example, a user preparing for a run may activate and initiate a running application and then activate and initiate a music application to listen to music while running. The systems and methods disclosed herein generate recommended commands that perform the different operations simultaneously or automatically, which reduced the inputs required by the user. Additionally, the systems and methods disclosed herein reduce overall processing times of a computing device through the efficient initiation and/or activation of applications and/or communicatively coupled devices (e.g., imaging devices, microphones, global-positioning systems, etc.). Further, the systems and methods disclosed herein allow for different combinations of applications and/or communicatively coupled devices to be combined to provide recommendations to users for the performance of operations that may have not been possible for the user. For example, application data, a global-positioning system, scheduling data, and/or other data can be used to generate a recommendation to adjust a user's route to work while the user is engaging on a run.

One example of a method of generating UI elements for recommended actions based on predicted commands determined by a machine learning system is described herein. This example method includes, while a user is interacting with an application presented at a display communicatively coupled with a computing device, determining, using a machine learning system a plurality of predicted commands to be performed by the user using the application and, for the plurality of predicted commands, an order for performing each predicted command of the plurality of predicted commands. The plurality of predicted commands is a subset of available commands at the application. The method further includes generating a recommended command user interface (UI) element for at least one predicted command of the plurality of predicted commands and causing presentation of the recommended command UI element at the display communicatively coupled with the computing device. The at least one predicted command is selected based on the order for performing each predicted command of the plurality of predicted commands.

Another example method of generating recommended commands using artificial intelligence is described. The method includes, in response to a first user input, initiating a recommended command workflow. The recommended command workflow includes presenting a first recommended command that can be performed by the computing device and/or an application in communication with the computing device. The first recommended command is one of a plurality of recommended commands determined based on user data and/or device data. The recommended command workflow also includes, in response to a second user input selecting the first recommended command, causing performance of the first recommended command at the computing device and/or the application, and presenting a second recommended command that can be performed by the computing device and/or the application. The second recommended command is one of the plurality of recommended commands and augments the first recommended command.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1C illustrate a sequential command recommendation system, in accordance with some embodiments.

FIGS. 2A-2G illustrate aggregated command recommendation systems, in accordance with some embodiments.

FIGS. 3A-3P illustrate application of the sequential command recommendation system and/or the aggregate command recommendation system in an AR environment, in accordance with some embodiments.

FIG. 4 illustrates a flow diagram of a method of generating UI elements for recommended actions based on predicted commands determined by a machine learning system, in accordance with some embodiments.

FIGS. 5A-5C-2 illustrate example XR systems that include AR and MR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) PIUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

As described herein, command recommendation systems provide recommended commands to be performed in and/or by applications (e.g., via application-specific user interfaces (UIs)). The command recommendations systems determine the recommended commands using machine learning systems (and/or other artificial intelligence (AI) models). In some embodiments, the command recommendation systems disclosed herein utilize AI guidance to present recommended commands to users. In some embodiments, the machine learning systems of the command recommendations systems utilize previously stored workflow histories, user preferences, available commands at an application, and/or other data to determine recommended commands. The command recommendation systems determine an order for performing a plurality of predicted commands and present the commands to a user. As described in detail below, the command recommendation systems can present the one or more recommended commands in sequence or in aggregate. The recommended commands (or recommended actions) are presented in user interfaces that include visual previews to assist users in visualizing a particular action. The command recommendation systems allow users to modify one or more recommended commands to perform a desired action and/or improve the accuracy of recommended actions. The command recommendation systems are configured to reduce user deliberation in performing a specific action, reduce the number of inputs required by a user to perform an action, and assist users in performing complex actions.

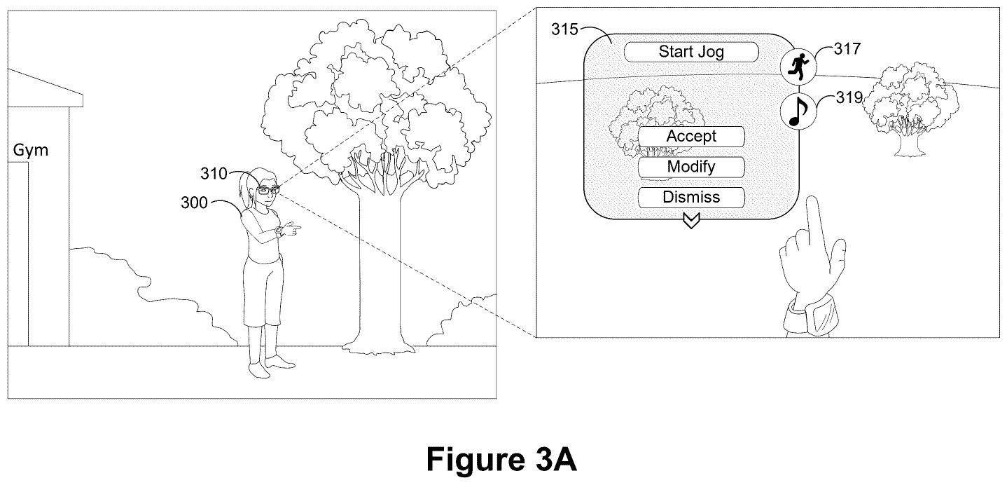

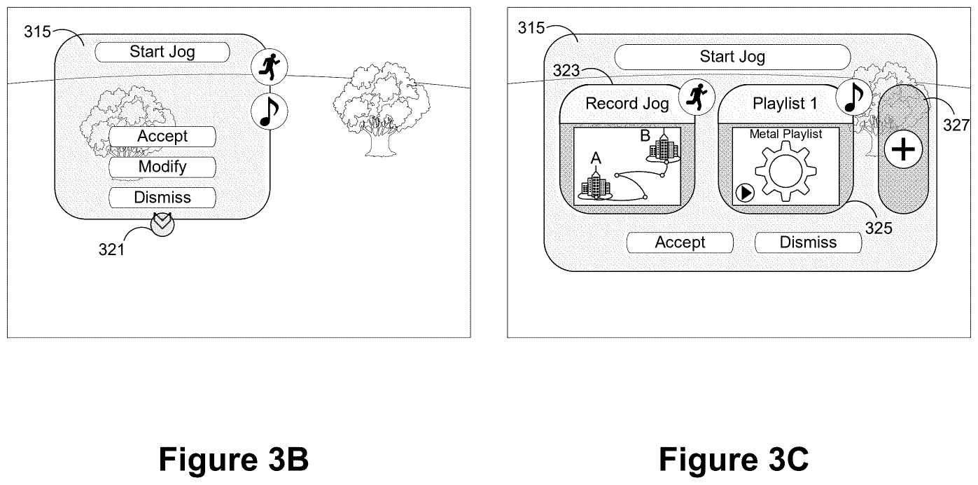

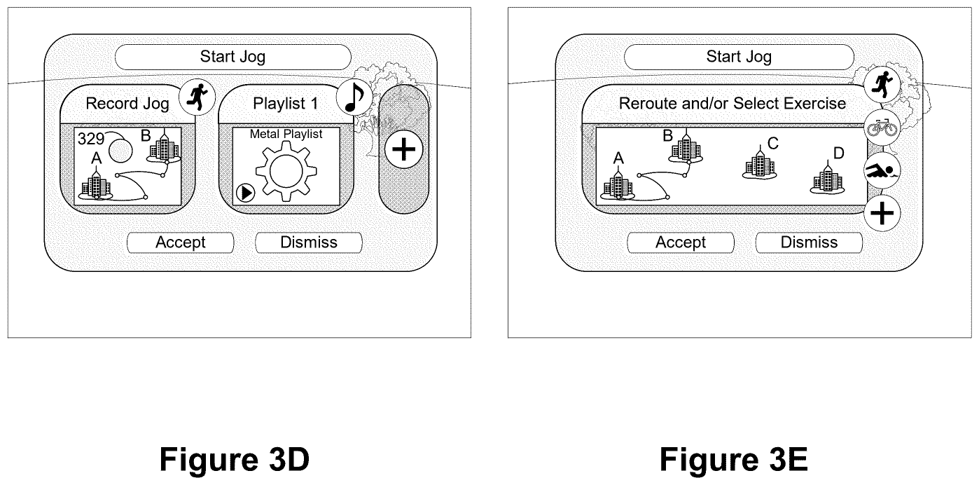

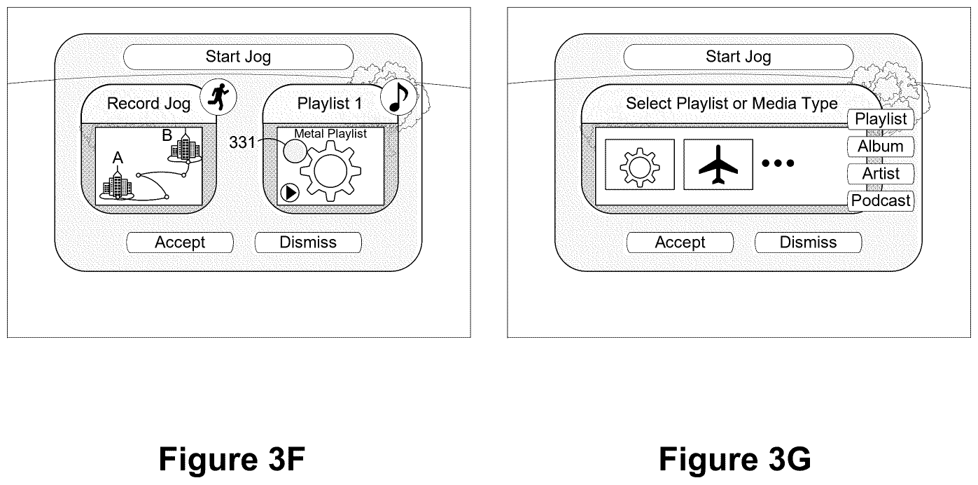

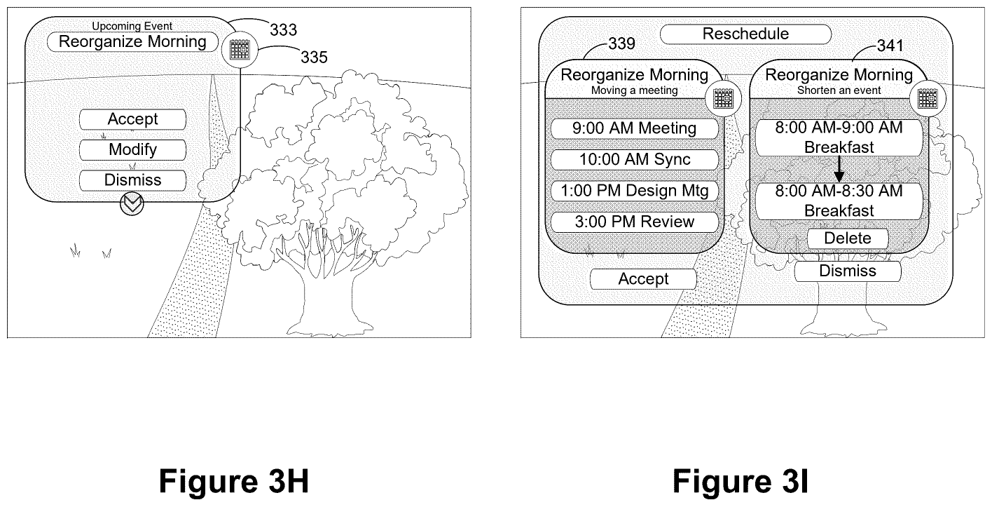

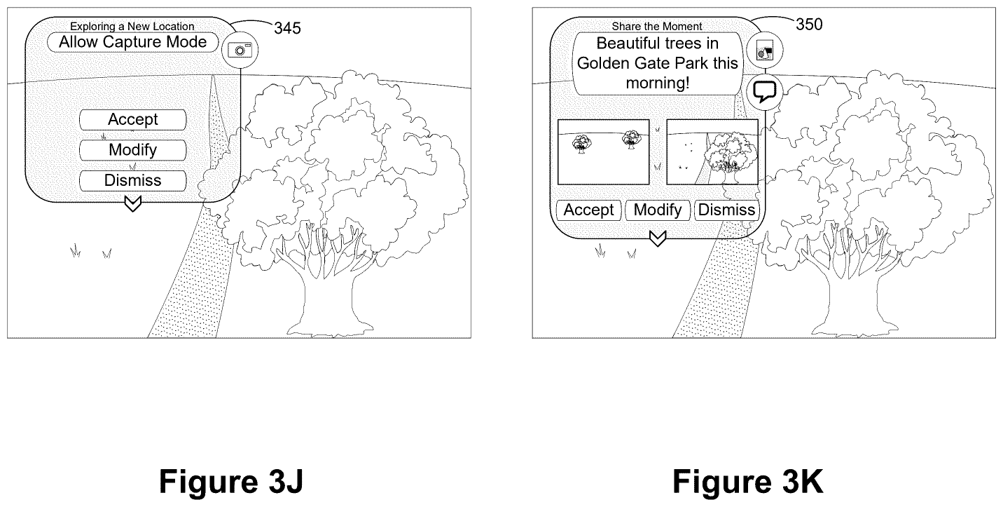

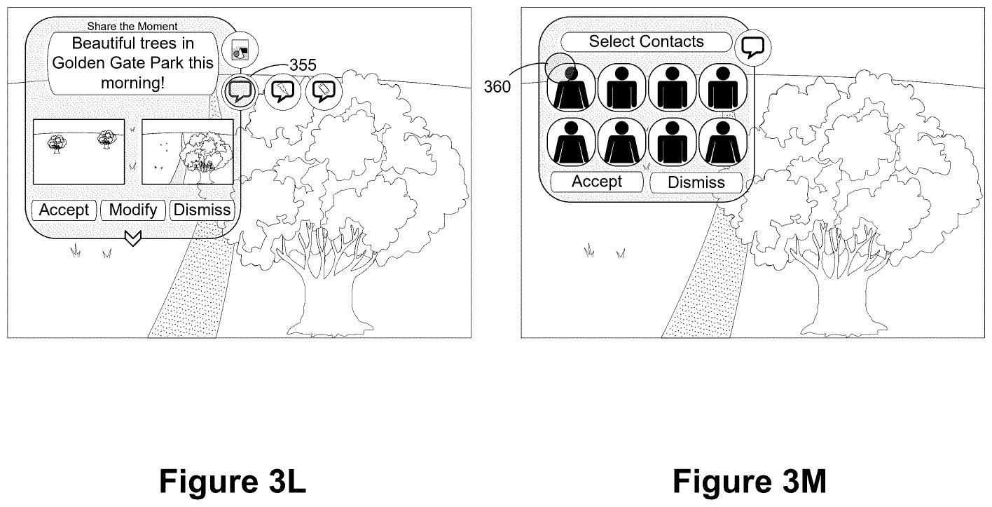

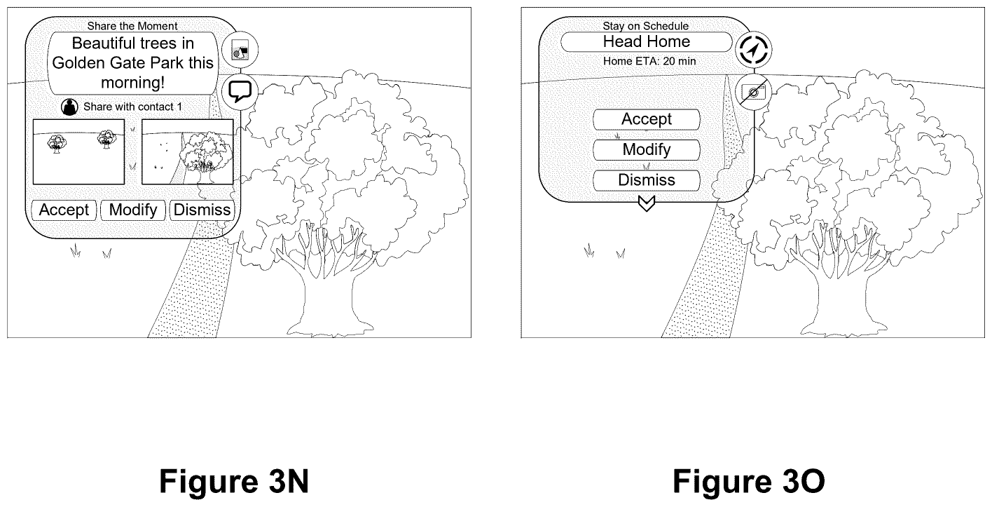

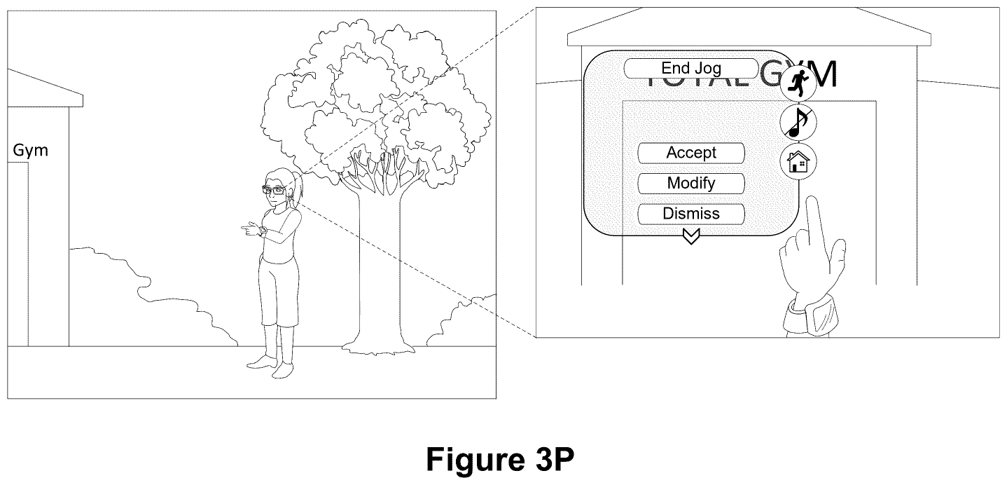

The command recommendation systems can be used with any variety of applications. Non-limiting examples of applications used with the command recommendation systems include drawing applications, Computer-Aided Design applications, 3D modeling applications, 3D sculpting applications, data analysis applications, and data visualization applications, word processing applications, photo editing applications, and/or any other type of application. For example, the command recommendation systems can recommend commands for editing a photograph (which can instruct a user to make particular color corrections or saturation adjustments that would require a sequence of isolated commands). The command recommendation systems can also be used with any variety of AR scenarios. For example, as shown and described in reference to FIGS. 3A-3P, the command recommendation systems can be used to recommend actions during an activity (e.g., running), while socializing, while at a particular location. The above examples are non-liming and the command recommendation systems can also be used in any number of AR scenarios.

### Sequential Command Recommendation

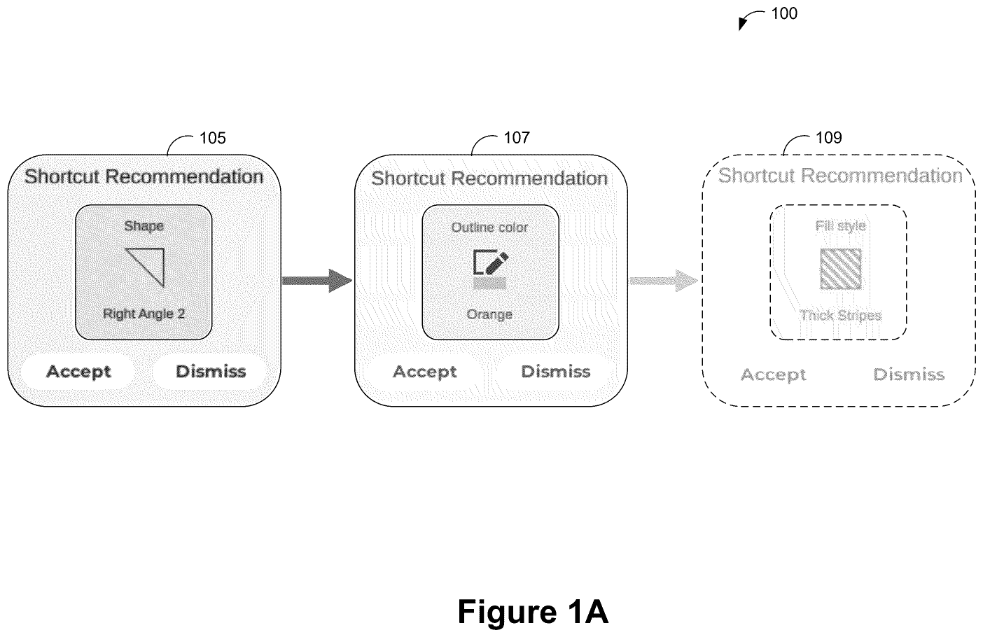

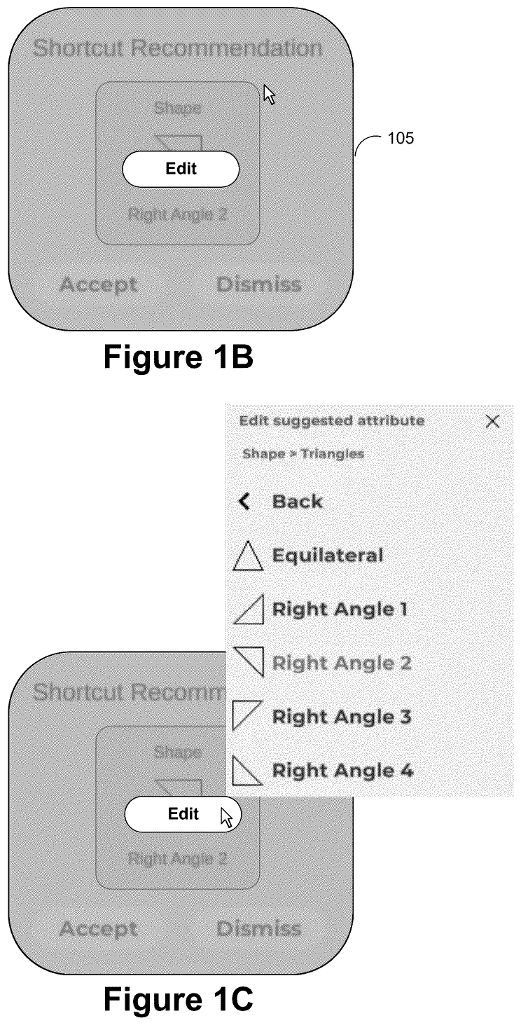

FIGS. 1A-1C illustrate a sequential command recommendation system, in accordance with some embodiments. The sequential command recommendation system 100 includes user interface (UI) elements for each recommended command. Specifically, the sequential command recommendation system 100 presents a recommended command UI element for each recommended command one at a time. By presenting each recommended command UI element individually, the sequential command recommendation system 100 allows a user to accept, edit, dismiss (or reject) each command before another command is presented. The sequential command recommendation system 100 presents a subsequent recommended command UI element after the user accepts or dismisses a currently presented recommended command UI element. Alternatively, in some embodiments, the sequential command recommendation system 100 ceases to present recommended command UI elements after the user has dismissed a predetermined number of recommended commands or dismisses the sequential command recommendation system 100.

Turning to FIG. 1A, at least three recommended command UI elements 107, 107, and 109 presented. Each of the recommended command UI elements are generated for predicted commands of a plurality of predicted commands. In some embodiments, the recommended command UI elements are presented in order based on the order for performing each predicted command of the plurality of predicted commands. Each of the recommended command UI elements includes a respective preview of the command or action to be performed in and/or by the application when the recommended command UI element is accepted. For example, selection of a first recommended command UI element 105 causes a shape having a right angle to be drawn in an application, selection of a second recommended command UI element 107 causes an outline of the drawn shaped (or future shapes) to be outlined with an orange line, and selection of a third recommended command UI element 109 causes an interior of the drawn shaped (or future shapes) to be filled in with thick stripes.

The plurality of predicted commands is determined using a machine learning system and are commands that are predicted to be performed by the user using the application. In other words, the plurality of predicted commands is a subset of available commands at a particular application. The machine learning system for determining the plurality of predicted commands is further configured to determine, for the plurality of predicted commands, an order for performing each predicted command of the plurality of predicted commands.

The sequential command recommendation system 100 presents the first recommended command UI element 105, individually, with the option to accept, dismiss, and/or edit via one or more UI elements. As shown and described below in reference to FIG. 1B, in some embodiments, UI elements for editing a recommended command are visible in response to an indication that the user is focused on the recommended command UI element (e.g., hovering a cursor over the recommended command UI element, tapping and holding on the recommended command UI element, maintaining a hand gesture selecting the recommended command UI element, gaze focused on the recommended command UI element, etc.). The second recommended command UI element 107 is presented in response to the user accepting or dismissing the first recommended command UI element 105, and the third recommended command UI element 109 is presented in response to the user accepting or dismissing the second recommended command UI element 107. In other words, the sequential command recommendation system 100 presents recommendations one at a time.

As shown in FIG. 1B, in response to an indication that the user is focused on the first recommended command UI element 105, an additional UI element for modifying the recommended command is presented. For example, as shown in FIG. 1B, the user hovers a cursor over the first recommended command UI element 105. In response to user selection of the additional UI element for editing the recommended command, a menu and/or modification UI elements are presented to the user. The indication that the user is focused on a particular recommended command UI element can be determined and/or inferred from one or more of sensor data, image data, user gaze, audio data (e.g., voice commands), hand gestures, user inputs, etc. For example, an indication that the user is focused on the first recommended command UI element 105 can be received in response to the user maintaining a hand gesture over the first recommended command UI element 105 (e.g., holding a pinch gesture). The above examples are non-limiting and different input means can be used to detect that a user is focused on a particular recommended command UI element.

FIG. 1C show the menu and/or modification UI elements presented to the user.

In some embodiments, the modifications presented to use user are based on the recommended command being edited. For example, the user selected to edit the recommended command for drawing a shape, as such, the user is presented with options for modifying the shape and/or selecting a new shape. In some embodiments, the user is able to define one or more parameters for the modification. For example, depending on the application and/or the recommended action, the user can provide define one or parameters for size, length, sides, colors, shape, view angle, etc.

Because the sequential command recommendation system 100 presents recommended command UI elements one at a time, the user can edit and control each action to be performed at an application. This allows the use to have greater control over the actions performed in an application through the use of the sequential command recommendation system 100.

### Aggregated Command Recommendation

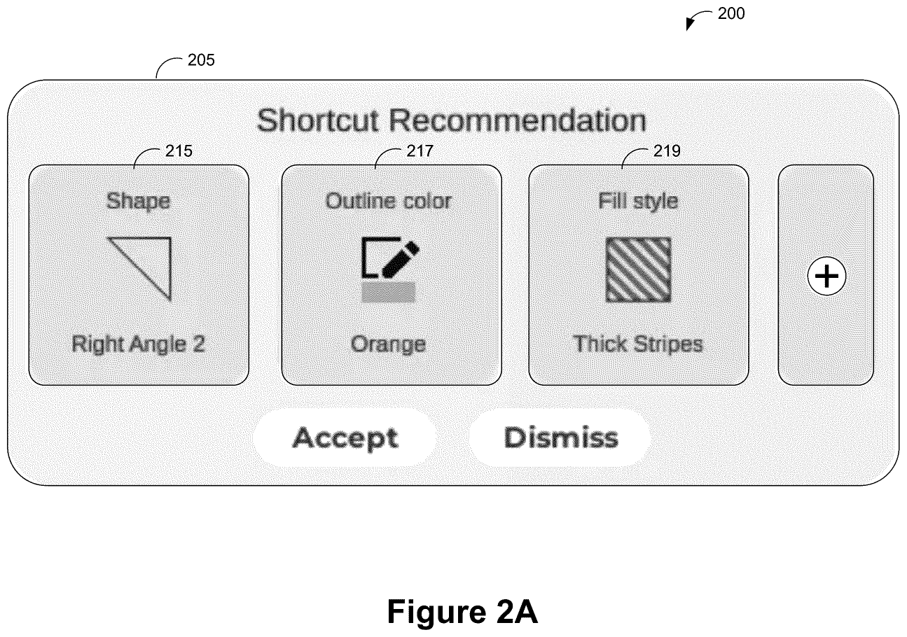

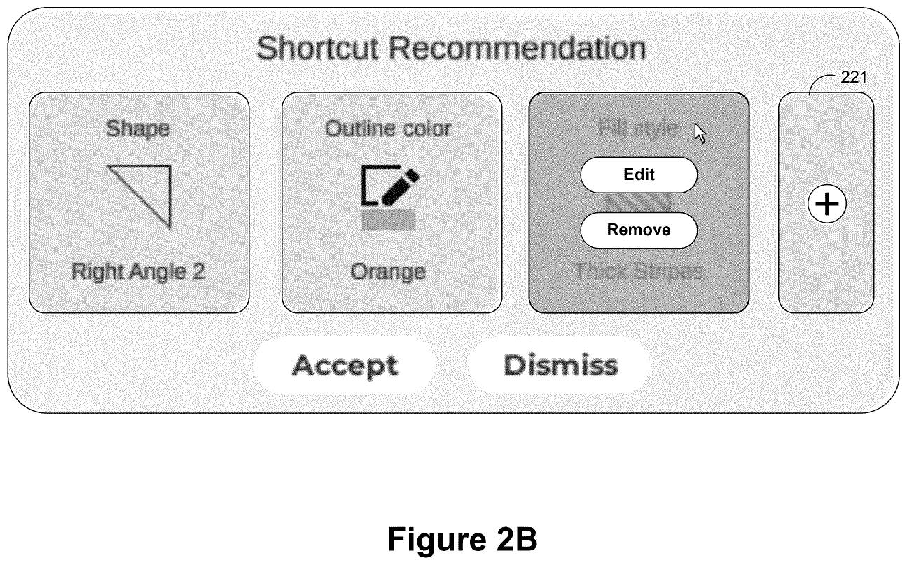

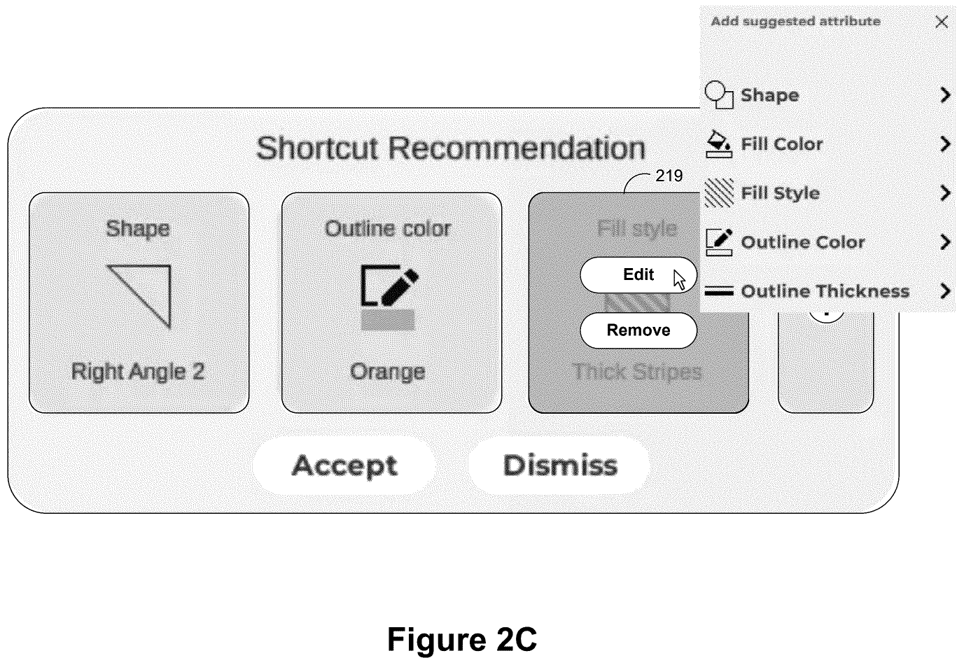

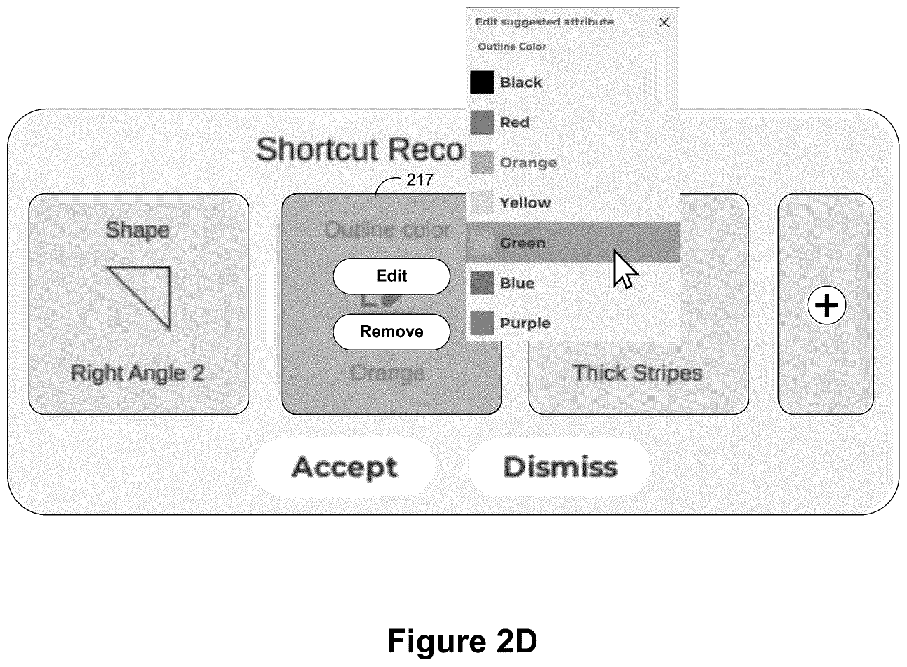

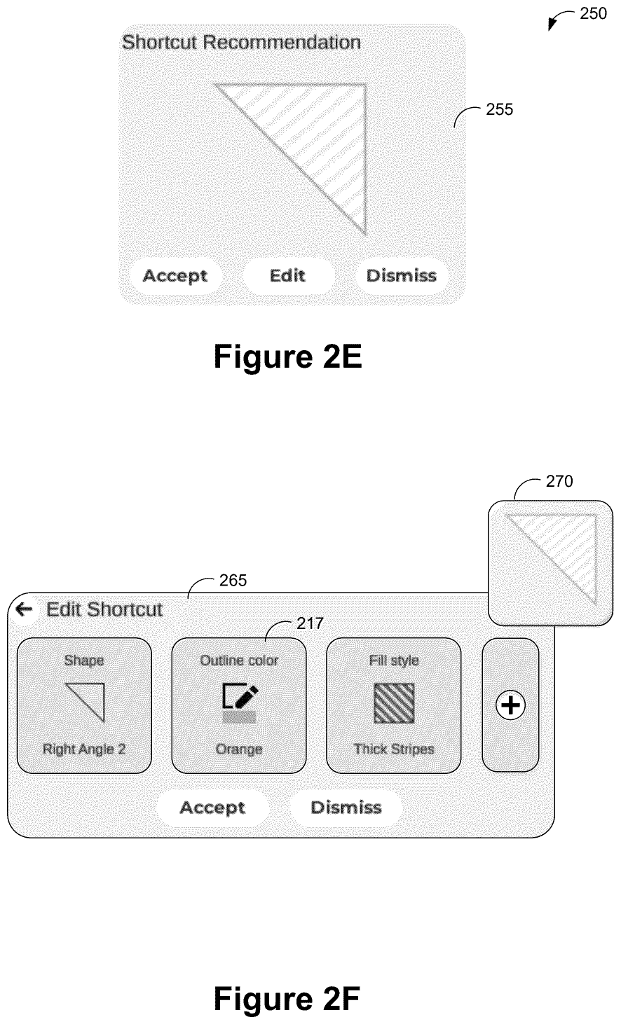

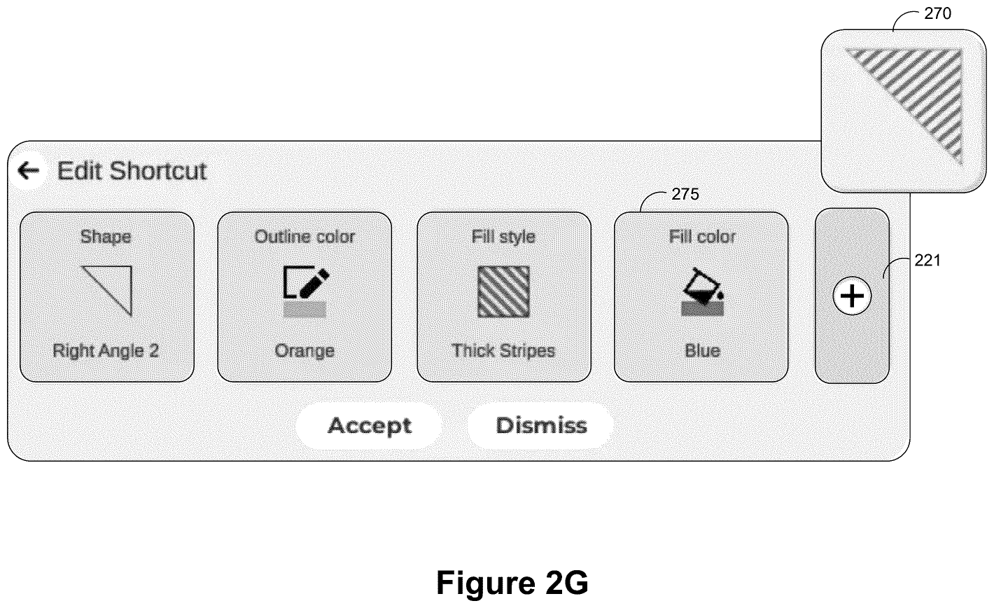

FIGS. 2A-2G illustrate aggregated command recommendation systems, in accordance with some embodiments. FIGS. 2A-2D show a first example aggregated command recommendation system 200 and FIGS. 2E-2G show a second aggregated command recommendation system 250. One or more features from the first and second aggregated command recommendation systems 200 and 250 are interchangeable. The aggregated command recommendation systems combine command recommendations into a single aggregate command UI element that can be executed or dismissed simultaneously. The aggregate UI element allows users to edit, add, and/or remove individual commands. In other words, the aggregated command recommendation systems present the plurality of predicted commands as a group within an aggregate command UI element and allow the user to evaluate and accept or reject the group as a whole, as well as make edits to the individual commands that make up the group. In some embodiments, the aggregate command UI includes one or more visual previews for assisting a user visualizing an outcome of a particular aggregate command (e.g., the visual previews are effective for supporting users engaged in open-ended tasks).

Turning to FIG. 2A, the first example aggregated command recommendation system 200 generates a first aggregate command UI element 205. In some embodiments, the first aggregate command UI element 205 includes one or more recommended command UI elements based on a plurality of predicted commands. As described above, the plurality of predicted commands and an order for performing one or more of the predicted commands within the plurality of predicted commands is determined using a machine-learning model. Each of the one or more recommended command UI elements within the first aggregate command UI element 205 represents a single action performed at an application. For example, a first recommended command UI element 215 causes a shape having a right angle to be drawn in an application, a second recommended command UI element 217 causes an outline of the drawn shaped (or future shapes) to be outlined with an orange line, and a third recommended command UI element 219 causes an interior of the drawn shaped (or future shapes) to be filled in with thick stripes.

When the user accepts the first aggregate command UI element 205, each of the recommended command UI elements within the first aggregate command UI element 205 are performed. In some embodiments, the recommended commands within the first aggregate command UI element 205 are performed in the same order in which they are presented (which corresponds to the order for performing the one or more of the predicted commands within the plurality of predicted commands). Alternatively, in some embodiments, the recommended commands within the first aggregate command UI element 205 are performed in an order most efficient and logical for the particular application. When the user dismisses the first aggregate command UI element 205, the first aggregate command UI element 205 is dismissed without causing performance of any recommended command UI element within the first aggregate command UI element 205.

As shown in FIG. 2B, a user can edit or remove recommended command UI elements within the first aggregate command UI element 205. In some embodiments, additional UI elements for editing or removing a recommended command UI element are presented when a user is focused on a particular recommended command UI element. As described above in reference to FIGS. 1A and 1i, an indication that a user is focused on a particular recommended command UI element can be determined in a number of different ways. Alternatively, or in addition, in some embodiments, the user can add additional command that they would like to be performed with the first aggregate command UI element 205. For example, selection of the plus sign UI element 221 causes presentation of a modal hierarchical menu from which additional commands can be selected. This provides the user with greater flexibility in causing the performance of a desired outcome.

In FIG. 2C, the user selected the additional UI element for editing the third recommended command UI element 219. In response to selection of the editing UI element, a menu including command specific modifications is presented. The modifications presented to the user are specific to the command. For example, as shown in FIG. 2D, the modifications presented to the user in response to selection of the editing UI element for the second recommended command UI element 217, are distinct from the modification included in the menu presented to the user in response to selection of the editing UI element for the third recommended command UI element 219. Selection of the remove UI element for a particular recommended UI element deletes the recommended command UI element from the first aggregate command UI element 205 (while keeping the remaining recommended command UI elements in the first aggregate command UI element 205).

Turning to FIG. 2E, the second example aggregated command recommendation system 250 generates a second aggregate command UI element 255. The second aggregate command UI element 255 presents a finalized visual preview of an executed aggregate command UI element. More specifically, a resulting output when the recommended command UI elements within second aggregate command UI element 255 are performed (e.g., if the second aggregate command UI element 255 is accepted). The second example aggregated command recommendation system 250 allows the user to visualize a final output without having to predict or extrapolate how individual commands would come together.

FIG. 2E shows editing of the second aggregate command UI element 255. In particular, in response to selection of the edit UI element in the second aggregate command UI element 255, the user is presented with an editing aggregate command UI element 265. The aggregate command UI element 265 allows the user to edit, remove, and/or add one or more recommended command UI elements within the second aggregate command UI element 255. The editing, removal, and/or adding of one or more recommended command UI elements within the second aggregate command UI element 252 is analogous to the process described above in reference to FIGS. 2A-2E.

In FIG. 2F, the editing aggregate command UI element 265 is presented with a draft visual preview UI element 270, which shows the user a resultant output of all the recommended actions or commands when performed. In some embodiments, the user can focus or select a particular recommended command UI element to cause a visual preview to be presented for the particular recommended command UI element. For example, a user highlighting or focusing on the second recommended command UI element 217 can cause the second example aggregated command recommendation system 250 to present of a visual preview of a triangle with an orange outline (e.g., performance of the first two recommended command UI elements 215 and 217 but not the third recommended command UI element 219).

FIG. 2G shows the addition of another recommended command UI element 275 and an update to the draft visual preview UI element 270. As described above, additional recommended command UI elements can be added via selection of the plus sign UI element 221.

### Command Recommendation System

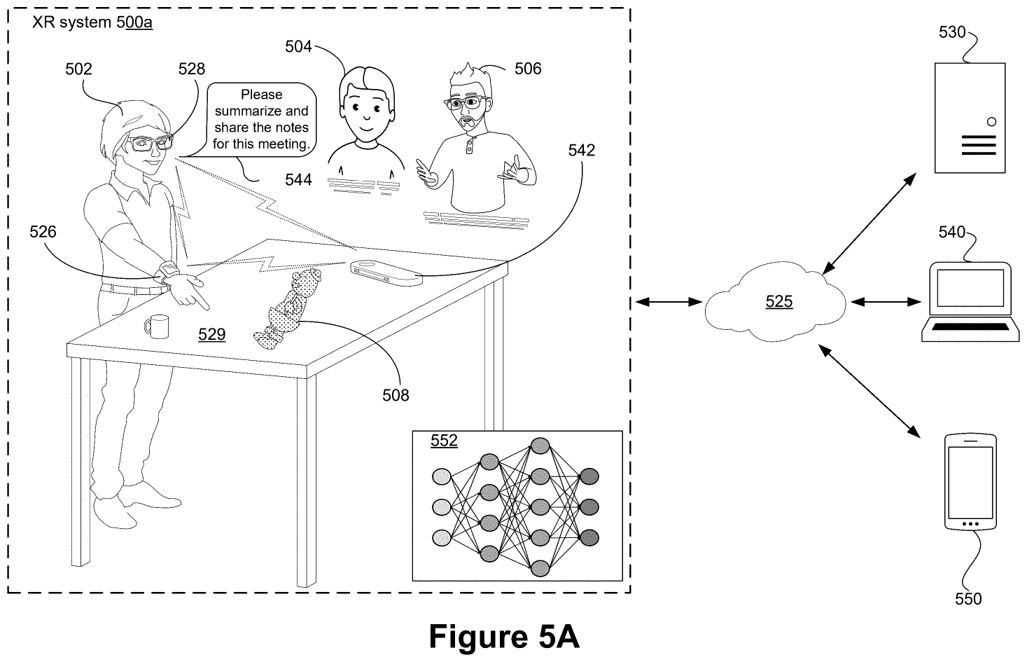

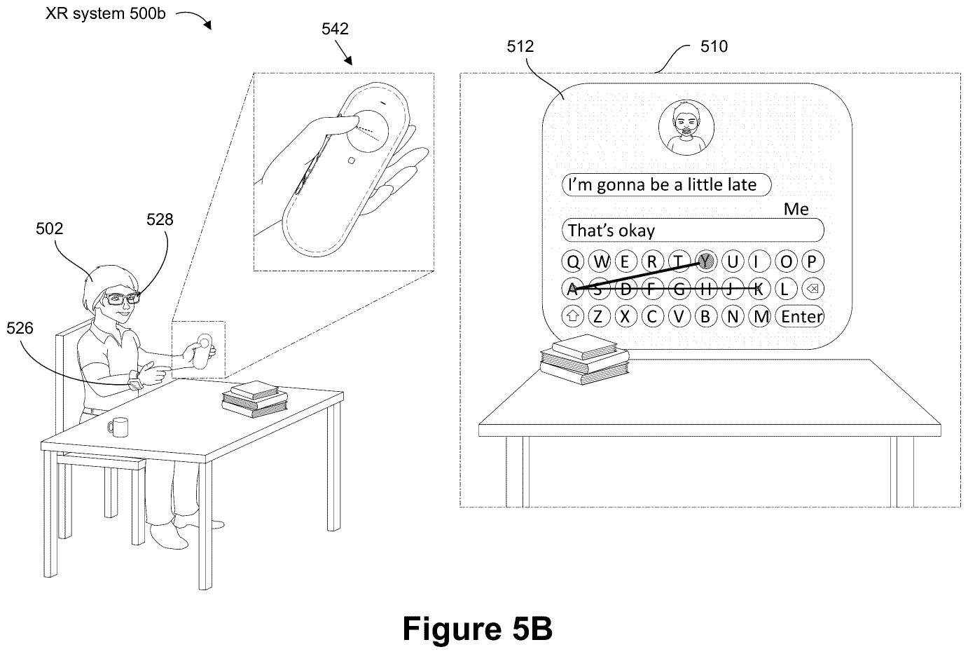

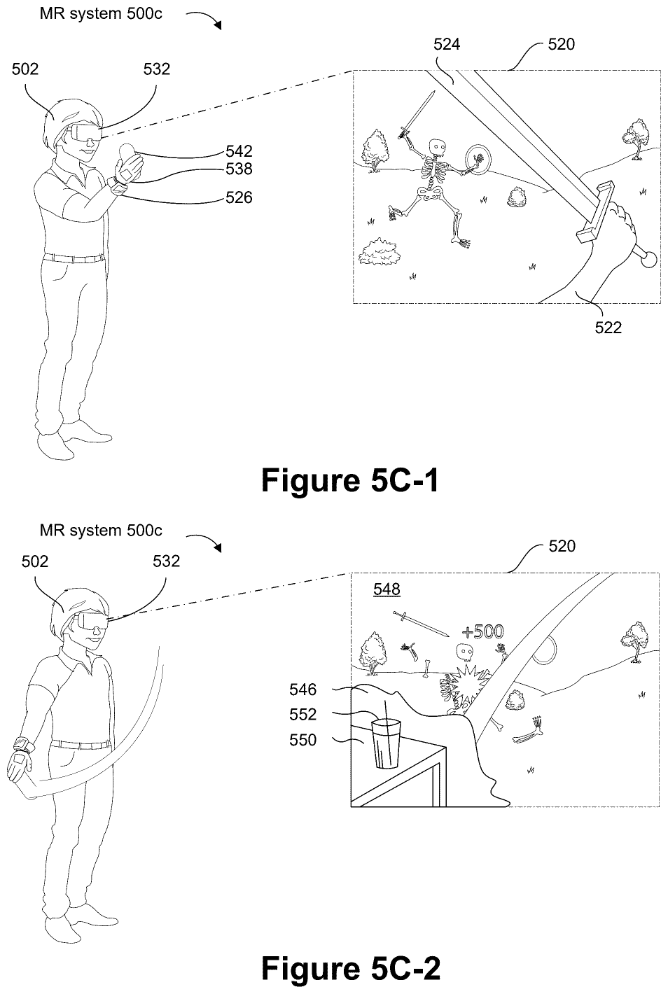

FIGS. 3A-3P illustrate application of the sequential command recommendation system and/or the aggregate command recommendation system in an AR environment, in accordance with some embodiments. A head-wearable device 310 worn by a user 300 presents an AR environment including one or more XR objects and/or XR augments. The head-wearable device 310 (analogous to AR device 528 and/or the MR devices 532; FIGS. 5A-5C) is configured to present XR objects and/or XR augments corresponding to commands recommended by the sequential command recommendation system 100 and/or the aggregate command recommendation system 200. The head-wearable device 310 and/or electronic devices communicatively coupled with the head-wearable device 310 (e.g., any device show and described below in reference to FIGS. 5A-5C) include instructions and/or programs stored in memory that, when executed by one or more respective processors, cause the performance of the operations of the sequential command recommendation system 100 and/or the aggregate command recommendation system 200.

In FIG. 3A, the user 300 is presented, via the head-wearable device 310, a first XR object 315 (e.g., “Start Jog”) including a command recommended by the command recommendation systems described above. The first XR object 315 corresponds to a recommended command determined by the sequential command recommendation system 100 (e.g., a single recommended command is presented at a time) and provided to the head-wearable device 310 for presentation. As described above in reference to FIGS. 1A-2G, the command recommendation systems determine, using a machine learning system, one or more recommended commands. The recommendation commands can be based on the user 300's location, history, schedule, habits, and/or other user data. For example, the “Start Jog” recommendation included in the first XR object 315 can be based on the user 300 scheduling a workout, proximity to a gym, regular routine, etc. In some embodiments, the first XR object 315 includes one or more operations or applications that will be initiated if the recommended command associated with the first XR object 315 is accepted. For example, the first XR object 315, if selected, will initiate a fitness application 317 and a music application 319.

FIG. 3B shows the user providing a first user input 321 selecting an XR object (e.g., a chevron pattern) for presenting addition settings. The user input can be provided via one or more hand gestures, voice commands, gaze detection, touch inputs at the head-wearable device 310 or a communicatively coupled device (e.g., a wrist-wearable device, a handheld intermediary processing device, a smartphone, etc.), etc. Alternatively, or in addition, the user 300 can select the “modify” XR object to cause the presentation of additional settings. The additional settings correspond to the recommended command presented by the recommendation system, as shown and described below.

Turning to FIG. 3C, the user 300 is presented, via the head-wearable device 310, additional XR objects for modifying or adjusting the first XR object 315. The additional XR objects can be one or more recommended commands determined by the command recommendation systems. In particular, the additional XR objects corresponds to recommended commands determined by an aggregated command recommendation system described above in reference to FIGS. 2A-2G (e.g., a plurality of recommended commands presented as part of a group). For example, a first additional XR object 323 corresponds to a recommended command for the fitness application 317, a second additional XR object 325 corresponds to a recommended command for the music application 319, and a third additional XR object 327 allows the user 300 to include additional commands to be performed, each of which are part of the group for the “Start Jog” recommended command determined in FIG. 3A. This allows the user to modify or adjust particular operations of a recommended command when performed.

FIG. 3D shows the user 300 providing a second user input 329 to modify or adjust the recommended command associated with the first additional XR object 323. For example, as shown in FIG. 3E, in response to the second user input 329, the user 300 is presented with additional XR objects for adjusting the recommended command to be performed by the fitness application 317. In FIG. 3E, the user is allowed to modify or adjust a route and/or select a distinct exercise. In some embodiments, the additional options presented are based on recommendations determined by the command recommendation systems described above.

FIG. 3F shows the user 300 providing a third user input 331 to modify or adjust the recommended command associated with the second additional XR object 325. For example, as shown in FIG. 3G, in response to the third user input 331, the user 300 is presented with additional XR objects for adjusting the recommended command to be performed by the music application 319. For example, the user 300 is allowed to modify or adjust media presented to the user during the performance of the operations executed when the recommended command corresponding to the first XR object 315 is accepted.

FIGS. 3H and 3I show dynamic recommendations provided to the user 300 while wearing the head-wearable device 310. In FIG. 3H, the user 300 accepted the first XR object 315, which caused the head-wearable device 310 and/or a communicatively coupled device to initiate the fitness application 317 for recording a jog and a music application 319 for presenting (e.g., via speakers of the head-wearable device 310) media content to the user 300. While the user 300 is engaging in the recommended activity, additional recommendations can be determined by the command recommendation systems and presented to the user. For example, as shown in FIG. 3H, the user 300 is presented with a second XR object 333 corresponding to a recommended command for adjusting the user 300's schedule. For example, based on the user 300's location; exercise duration; calendar events; running pace; and/or other factors, the command recommendation systems can present the user with a recommendation for reorganizing their schedule via a calendar application 335.

FIG. 3I shows additional XR objects presented to the user to modify or adjust how their calendar is recognized. The recommended calendar reorganizations are determined by the command recommendation systems described above. For example, a first reorganization XR object 339 can present the user 300 with a snapshot of their day to allow the user 300 to select one or more events to adjust, remove, reschedule, and/or add. Alternatively, or in addition, in some embodiments, the user is presented with a second reorganization XR object 341 that recommends a schedule adjustment to the user 300 (e.g., shorten breakfast from 1 hour to 30 minutes).

FIGS. 3J-3N show additional dynamic recommendations provided to the user 300 while wearing the head-wearable device 310. In FIG. 3J, while the user 300 is engaging in the recommended activity of FIG. 3A, additional recommendations are determined by the command recommendation systems and presented to the user. In particular, the user 300 is presented with a third XR object 345 corresponding to a recommended command for capturing image data of the user 300's field of view. In some embodiments, the recommendation is based on landmarks, trigger conditions (e.g., blooming flowers), events in proximity to the user, season (e.g., blooming season), user request to capture data, and/or other data.

In FIG. 3K, after the user 300 accepted the recommendation to capture image data, the user 300 is presented with one or more captured images. The captured images are presented with one or more additional recommendations determined by the command recommendation systems. For example, a fourth XR object 350 presented to the user 300 includes a recommendation to view the captured image data in a gallery application and/or send the captured image data in a message (e.g., via a messaging application). Additionally, the command recommendation system can determine an explanation and/or description to accompany the captured image data. For example, the fourth XR object 350 includes the description “Beautiful trees in Golden Gate Park this morning!” to accompany the captured image data. The explanation and/or description can be based on the captured images, location of the captured images, user prompts, etc.

FIG. 3L shows the user 300 providing an input to select an application for sending the captured image data and/or descriptions. In particular, a user input 355 is provided selecting an initial messaging application selected for a recommended command determined by the by the command recommendation systems. In response to the user input 355, the user 300 is presented with other applications available for sending the captured image data. In FIG. 3M, the user 300 provides an additional user input 360 to select a respective contact for sharing the captured image data. In some embodiments, the command recommendation systems can recommend one or more contacts to the user 300 or list the contacts in particular order (e.g., from most commonly messaged to least commonly messaged). FIG. 3N show the modified fourth XR object 350 including the selected contact and captured image data.

FIG. 3O shows a recommended command to return home. The command recommendation systems can provide a recommendation to the user 300 to head back to their starting location or other location based on one or more factors (e.g., upcoming events, travel time, location, etc.). The recommended command can include one or more operations to be performed at one or more applications. For example, user acceptance of the recommended command to return home (or back to the gym) includes initiating a map or GPS application to guide the user 300 back to their starting location and disabling a camera (e.g., to protect the user 300's privacy such that their route back is not captured).

Turning to FIG. 3P, a recommended command for ending a workout is presented to the user 300. The recommended command can include one or more operations to be performed at one or more applications. For example, user acceptance of the recommended command to end their activity includes initiating the fitness application to log their workout and terminate the music application. In some embodiments, events or notifications outside of a current activity are logged and presented to the user 300 at completion of the activity (e.g., if do not disturb is enabled). For example, a user 300's smart doorbell or home security camera may have captured a visitor and the command recommendation systems can present the notification or event to the user at completion of the workout. For example, in FIG. 3P, a home control application is presented in conjunction with the fitness application to allow the user 300 to access or control one or more home control operations.

The above examples are non-limiting. The command recommendation systems can recommend any number of operations or commands to be performed at distinct applications. For example, the command recommendation systems can recommend one or more commands for ordering food or other services via a shopping or food delivery application, split or share bills with friends, select media to be played via communicatively coupled devices (e.g., such as a television), adjust home conditions (e.g., lighting, air conditioning, garage door, etc.), placing orders at a restaurant; coffee shop; or other location, study tools, and/or other commands. In some embodiments, the command recommendation systems perform image processing and/or audio processing to determine one or more recommended commands. For example, while at a coffee shop, an image of a poster for an upcoming concert can be captured and a recommended command for attending or sharing the concert with a contact can be presented to the user. In another example, a song may be playing in a coffee store and an audio clip of the song can be captured and a recommended command for identifying and adding the song to a playlist can be presented to the user.

### Method of Generating Recommended Actions

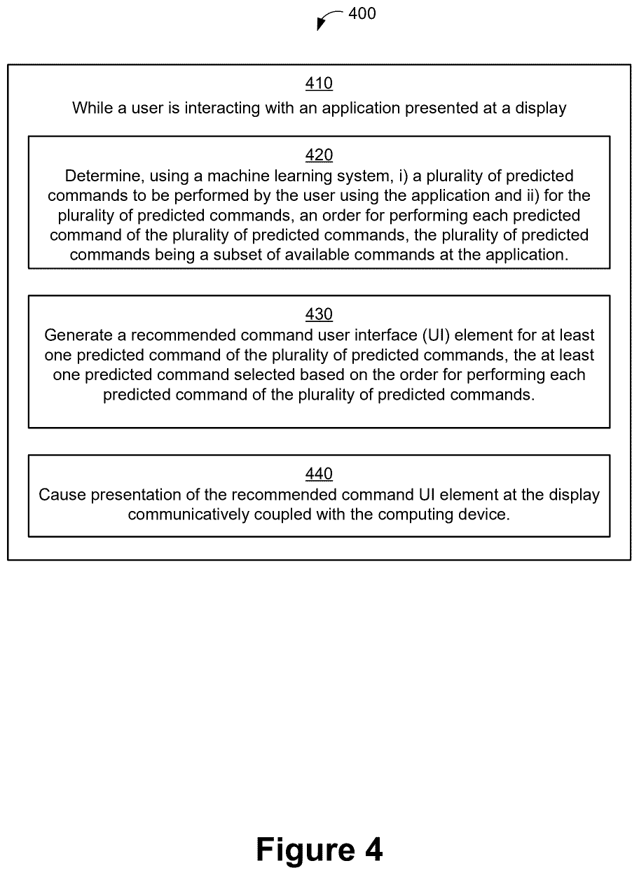

FIG. 4 illustrates a flow diagram of a method of generating UI elements for recommended actions based on predicted commands determined by a machine learning system, in accordance with some embodiments. Operations (e.g., steps) of the method 400 can be performed by one or more processors (e.g., central processing unit and/or MCU) of a system (e.g., central processing units and/or MCUs of one or more devices of systems 500a-500c; FIGS. 5A-5C). At least some of the operations shown in FIG. 4 correspond to instructions stored in a computer memory or computer-readable storage medium (e.g., storage, RAM, and/or memory of at least one device). Operations of the method 400 can be performed by a single device alone or in conjunction with one or more processors and/or hardware components of another communicatively coupled device (e.g., any device show of systems 500a-500c; FIGS. 5A-5C) and/or instructions stored in memory or computer-readable medium of the other device communicatively coupled to the system. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device, but should not be construed as limiting the performance of the operation to the particular device in all embodiments.

(A1) FIG. 4 shows a flow chart of a method 400 of generating UI elements for recommended actions based on predicted commands determined by a machine learning system, in accordance with some embodiments. The method 400 occurs at a computing device communicatively coupled with a display. In some embodiments, the method 400 includes, while a user is interacting (410) with an application presented at the display communicatively coupled with the computing device, determining (420), using a machine learning system a plurality of predicted commands to be performed by the user using the application and, for the plurality of predicted commands, an order for performing each predicted command of the plurality of predicted commands. The plurality of predicted commands is a subset of available commands at the application. The method 400 further includes generating (430) a recommended command user interface (UI) element for at least one predicted command of the plurality of predicted commands and causing presentation of the recommended command UI element at the display communicatively coupled with the computing device. The at least one predicted command is selected based on the order for performing each predicted command of the plurality of predicted commands. For example, as shown in FIGS. 1A-3P, the command recommendation systems are configured to generate and present recommended commands UI elements to the user. For the sequential command recommendation system shown in FIG. 1A-1C, the recommendation command UI elements are presented one at a time based on the order of for performing each predicted command of the plurality of predicted commands. For the aggregate command recommendation system shown in FIG. 2A-2G, an aggregate command UI element is generated that includes one or more recommended command UI elements based on the plurality of predicted commands. Application of the sequential command recommendation system and/or the aggregate command recommendation system in an AR environment are shown and described above in reference to FIGS. 3A-3P.

(A2) In some embodiments of A1, the recommended command UI element is a first recommended command UI element and the at least one predicted command is a first predicted command, and the method further includes, after user selection of the first recommended command UI element, causing performance of a first command of the available commands at the application associated with the first predicted command and generating a second recommended command UI element for a second predicted command of the plurality of predicted commands. The second predicted command is ordered subsequent the first predicted command. The method also includes causing presentation of the second recommended command UI element at the display communicatively coupled with the computing device. For example, as described above in reference to FIGS. 1A-1C, a subsequent recommended command UI element is presented after the user has accepted or denied a currently presented recommended command UI element.

(A3) In some embodiments of A1, the recommended command UI element for the at least one predicted command of the plurality of predicted commands includes respective UI elements for each predicted command of the plurality of predicted commands, each respective UI element presented in order based on the determined order for performing each predicted command of the plurality of predicted commands. In other words, as shown and described above in reference to FIGS. 2A-2G, in some embodiments, the recommendation command UI elements are presented in order within the aggregate command UI element based on the order of for performing each predicted command of the plurality of predicted commands.

(A4) In some embodiments of A3, the method further includes in response to user selection of the recommended command UI element, causing performance of respective commands of the available commands at the application associated with the plurality of predicted commands. As described above in reference to FIGS. 2A-2G, acceptance of the aggregate command UI element causes the performance of each recommendation command within the aggregate command UI element.

(A5) In some embodiments of A4, the respective commands of the available commands at the application are performed in the determined order for performing each predicted command of the plurality of predicted commands. In other words, the recommendation commands within the aggregate command UI element can be performed sequentially until all the recommended commands are complete.

(A6) In some embodiments of any one of A1-A5, the method includes in response to an indication that the user is focused on the recommended command UI element, presenting an additional UI element within the recommended command UI element. The additional UI element, when selected, allows for modification of the at least one predicted command. For example, as shown in FIGS. 1A-2G, a user can select an additional UI element to edit, remove, or add commands to be performed.

(A7) In some embodiments of A6, the modification of the at least one predicted command includes one or edit, remove, and add.

(B1) In accordance with some embodiments, a method of generating recommended commands is disclosed. The method includes, in response to a first user input, initiating a recommended command workflow. The recommended command workflow, when initiated, causes presentation, via a display communicatively coupled with a computing device, a first recommended command that can be performed by one or more of the computing device and an application in communication with the computing device. The first recommended command is one of a plurality of recommended commands determined based on one or more of user data and device data. The recommended command workflow also, in response to a second user input selecting the first recommended command, causes performance of the first recommended command at one or more of the computing device and the application and presents, via the display, a second recommended command that can be performed by one or more of the computing device and the application. The second recommended command is one of the plurality of recommended commands and augments the first recommended command (e.g., builds on and/or adds to the first recommended command).

For example, as shown in FIGS. 3A-3P, the user is presented an AR environment including one or more XR objects and/or XR augments. The XR objects and/or XR augments include recommended commands (e.g., sequential command recommendation and/or aggregate command recommendations) that can be performed at a computing device (e.g., a head-wearable device, wrist-wearable device, mobile device, etc.) and/or an application in communication with the computing device. The recommended command workflow and the recommended commands of the plurality of recommended commands are determined by a machine learning model or artificial intelligence model that uses user data and device data to generate sequential and/or non-sequential operations that could be performed at one or more of the computing device and the application in communication with the computing device. For example, in reference to FIGS. 3A-3P, the user data can include a workflow history of operations performed by one or more of the computing device and the application in communication with the computing device while the user is at a gym, and, based on the workflow history, the machine learning model or artificial intelligence model generates the recommended command workflow and the recommended commands of the plurality of recommended commands.

Non limiting examples of the user data and device data used by the machine learning model or artificial intelligence model in determining the recommended command workflow and the recommended commands of the plurality of recommended commands includes previous user inputs or activity at the computing device and/or application, location data, image data, schedule data, time of day, day, contacts, to-do lists, goals, travel time, etc.

(B2) In some embodiments of B1, the first recommended command and the second recommended command are associated with operations performed in sequential order. For example, as shown in FIGS. 3J and 3K, a first recommended command to capture image data is presented to the user and, in response to the user selecting the first recommended command (e.g., accept), image data is captured and a second recommended command to share the captured image data is presented to the user.

(B3) In some embodiments of any of B1-B2, the first recommended command includes an aggregation of at least two operations. For example, as shown in FIGS. 3A-3C, a first recommended command includes a record jog command and a play playlist 1 command. Selection of the first recommended command causes the computing device and/or the application(s) in communication with the computing device to perform the record jog command and the play playlist 1 command.

(B4) In some embodiments of any of B1-B3, the method further includes in response to a third user input disregarding the first recommended command, presenting, via the display, a third recommended command that can be performed by one or more of the computing device and the application. The third recommended command is one of the plurality of recommended commands and a continuation of the recommended command workflow. For example, as shown in FIGS. 3A-3C, the user provides a user input that does not select the “start jog” recommended command and is presented with additional recommended commands.

(B5) In some embodiments of B4, the first recommended command and the third recommended command are associated with operations performed in nonsequential order. For example, in reference to FIGS. 3H-3K, the user can disregard or ignore the recommended command for reorganizing their schedule and, in response to the user disregarding the recommended command for reorganizing, the user can be presented with a recommended command for capturing image data.

(B6) In some embodiments of any of B1-B5, the method further includes in response to a fourth user input selecting the second recommended command, causing performance of the second recommended command at one or more of the computing device and the application, and, in accordance with a determination that the second recommended command is an ending recommended command of the recommended command workflow, terminating the recommended command workflow. For example, as shown in FIGS. 3O and 3P, in response to user selection of the recommended command for ending the jog, the recommended command workflow is ended. In other words, because the user's physical activity session is complete, the recommended command workflow concludes. A new recommended command workflow can be initiated by a subsequent input provided by the user. For example, after the user's physical activity session ends (and the associated physical activity recommended command workflow ends), the user can initiate a new recommended command workflow when the provide a user input for directions home or to work. In other words, recommended command workflow are updated in real-time to continuously recommend commands to the user that would reduce their overall deliberation time, and when a particular recommended command workflow ends (e.g., no additional suggested recommended commands are available) a new recommended command workflow can be initiated based on the user's subsequent inputs. In some embodiments, the transition between the different recommended command workflows is seamless (e.g., different pluralities of recommended commands for respective recommended command workflows can be presented to the user without interruption or creation of user friction).

(B7) In some embodiments of any of B1-B6, presenting, via the display, the first recommended command includes presenting a modification command. The modification command, when selected, allows for the performance of one or more operations for editing a command of the plurality of recommended commands, removing a command of the plurality of recommended commands, and adding commands to the plurality of recommended commands. For example, as shown in FIGS. 3A-3P, the user is presented with options for modifying the recommended command or the plurality of recommended commands.

(B8) In some embodiments of any of B1-B7, wherein the plurality of recommended commands include recommended command UI elements generated in accordance with any of A1-A7. Different examples of the recommended command UI elements are shown in reference to FIGS. 1A-3P.

(C1) In accordance with some embodiments, a system that includes one or more wrist wearable devices, an artificial-reality headset, a handheld intermediary processing device, or other computing device and the system is configured to perform operations corresponding to any of A1-B8.

(D1) In accordance with some embodiments, a non-transitory computer readable storage medium including instructions that, when executed by a computing device in communication with a display, cause the computer device to perform operations corresponding to any of A1-B8.

(E1) In accordance with some embodiments, an electronic device communicatively coupled with a display, the electronic device including one or more programs, stored in memory and configured to be executed by one or more processors of the electronic device, the one or more programs including instructions for performing operations that correspond to any of A1-B8.

(F1) In accordance with some embodiments, a means for performing or causing the performance of the operations that correspond to any of A1-B8.

While the above examples describe the sequential and aggregated command recommendation systems as separate and distinct systems, as one of ordinary skill in the art will appreciate upon reading the descriptions provided herein, the different systems can be combined into a single command recommendation system. For example, a single (sequential) recommended command UI element can be presented and, upon acceptance or dismissal of the single (sequential) recommended command UI element, followed by an aggregate command UI element. This allows for the system to separate discrete tasks from large and/or complex tasks.

The devices described above are further detailed below, including systems, wrist-wearable devices, headset devices, and smart textile-based garments. Specific operations described above may occur as a result of specific hardware, such hardware is described in further detail below. The devices described below are not limiting and features on these devices can be removed or additional features can be added to these devices. The different devices can include one or more analogous hardware components. For brevity, analogous devices and components are described below. Any differences in the devices and components are described below in their respective sections.

### Example Extended-Reality Systems

FIGS. 5A-5C-2 illustrate example XR systems that include AR and MR systems, in accordance with some embodiments. FIG. 5A shows a first XR system 500a and first example user interactions using a wrist-wearable device 526, a head-wearable device (e.g., AR device 528), and/or a HIPD 542. FIG. 5B shows a second XR system 500b and second example user interactions using a wrist-wearable device 526, AR device 528, and/or an HIPD 542. FIGS. 5C-1 and 5C-2 show a third MR system 500c and third example user interactions using a wrist-wearable device 526, a head-wearable device (e.g., an MR device such as a VR device), and/or an HIPD 542. As the skilled artisan will appreciate upon reading the descriptions provided herein, the above-example AR and MR systems (described in detail below) can perform various functions and/or operations.

The wrist-wearable device 526, the head-wearable devices, and/or the HIPD 542 can communicatively couple via a network 525 (e.g., cellular, near field, Wi-Fi, personal area network, wireless LAN). Additionally, the wrist-wearable device 526, the head-wearable device, and/or the HIPD 542 can also communicatively couple with one or more servers 530, computers 540 (e.g., laptops, computers), mobile devices 550 (e.g., smartphones, tablets), and/or other electronic devices via the network 525 (e.g., cellular, near field, Wi-Fi, personal area network, wireless LAN). Similarly, a smart textile-based garment, when used, can also communicatively couple with the wrist-wearable device 526, the head-wearable device(s), the HIPD 542, the one or more servers 530, the computers 540, the mobile devices 550, and/or other electronic devices via the network 525 to provide inputs.

Turning to FIG. 5A, a user 502 is shown wearing the wrist-wearable device 526 and the AR device 528 and having the HIPD 542 on their desk. The wrist-wearable device 526, the AR device 528, and the HIPD 542 facilitate user interaction with an AR environment. In particular, as shown by the first AR system 500a, the wrist-wearable device 526, the AR device 528, and/or the HIPD 542 cause presentation of one or more avatars 504, digital representations of contacts 506, and virtual objects 508. As discussed below, the user 502 can interact with the one or more avatars 504, digital representations of the contacts 506, and virtual objects 508 via the wrist-wearable device 526, the AR device 528, and/or the HIPD 542. In addition, the user 502 is also able to directly view physical objects in the environment, such as a physical table 529, through transparent lens(es) and waveguide(s) of the AR device 528. Alternatively, an MR device could be used in place of the AR device 528 and a similar user experience can take place, but the user would not be directly viewing physical objects in the environment, such as table 529, and would instead be presented with a virtual reconstruction of the table 529 produced from one or more sensors of the MR device (e.g., an outward facing camera capable of recording the surrounding environment).

The user 502 can use any of the wrist-wearable device 526, the AR device 528 (e.g., through physical inputs at the AR device and/or built-in motion tracking of a user's extremities), a smart-textile garment, externally mounted extremity tracking device, the HIPD 542 to provide user inputs, etc. For example, the user 502 can perform one or more hand gestures that are detected by the wrist-wearable device 526 (e.g., using one or more EMG sensors and/or IMUs built into the wrist-wearable device) and/or AR device 528 (e.g., using one or more image sensors or cameras) to provide a user input. Alternatively, or additionally, the user 502 can provide a user input via one or more touch surfaces of the wrist-wearable device 526, the AR device 528, and/or the HIPD 542, and/or voice commands captured by a microphone of the wrist-wearable device 526, the AR device 528, and/or the HIPD 542. The wrist-wearable device 526, the AR device 528, and/or the HIPD 542 include an artificially intelligent digital assistant to help the user in providing a user input (e.g., completing a sequence of operations, suggesting different operations or commands, providing reminders, confirming a command). For example, the digital assistant can be invoked through an input occurring at the AR device 528 (e.g., via an input at a temple arm of the AR device 528). In some embodiments, the user 502 can provide a user input via one or more facial gestures and/or facial expressions. For example, cameras of the wrist-wearable device 526, the AR device 528, and/or the HIPD 542 can track the user 502's eyes for navigating a user interface.

The wrist-wearable device 526, the AR device 528, and/or the HIPD 542 can operate alone or in conjunction to allow the user 502 to interact with the AR environment. In some embodiments, the HIPD 542 is configured to operate as a central hub or control center for the wrist-wearable device 526, the AR device 528, and/or another communicatively coupled device. For example, the user 502 can provide an input to interact with the AR environment at any of the wrist-wearable device 526, the AR device 528, and/or the HIPD 542, and the HIPD 542 can identify one or more back-end and front-end tasks to cause the performance of the requested interaction and distribute instructions to cause the performance of the one or more back-end and front-end tasks at the wrist-wearable device 526, the AR device 528, and/or the HIPD 542. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 542 can perform the back-end tasks and provide the wrist-wearable device 526 and/or the AR device 528 operational data corresponding to the performed back-end tasks such that the wrist-wearable device 526 and/or the AR device 528 can perform the front-end tasks. In this way, the HIPD 542, which has more computational resources and greater thermal headroom than the wrist-wearable device 526 and/or the AR device 528, performs computationally intensive tasks and reduces the computer resource utilization and/or power usage of the wrist-wearable device 526 and/or the AR device 528.

In the example shown by the first AR system 500a, the HIPD 542 identifies one or more back-end tasks and front-end tasks associated with a user request to initiate an AR video call with one or more other users (represented by the avatar 504 and the digital representation of the contact 506) and distributes instructions to cause the performance of the one or more back-end tasks and front-end tasks. In particular, the HIPD 542 performs back-end tasks for processing and/or rendering image data (and other data) associated with the AR video call and provides operational data associated with the performed back-end tasks to the AR device 528 such that the AR device 528 performs front-end tasks for presenting the AR video call (e.g., presenting the avatar 504 and the digital representation of the contact 506).

In some embodiments, the HIPD 542 can operate as a focal or anchor point for causing the presentation of information. This allows the user 502 to be generally aware of where information is presented. For example, as shown in the first AR system 500a, the avatar 504 and the digital representation of the contact 506 are presented above the HIPD 542. In particular, the HIPD 542 and the AR device 528 operate in conjunction to determine a location for presenting the avatar 504 and the digital representation of the contact 506. In some embodiments, information can be presented within a predetermined distance from the HIPD 542 (e.g., within five meters). For example, as shown in the first AR system 500a, virtual object 508 is presented on the desk some distance from the HIPD 542. Similar to the above example, the HIPD 542 and the AR device 528 can operate in conjunction to determine a location for presenting the virtual object 508. Alternatively, in some embodiments, presentation of information is not bound by the HIPD 542. More specifically, the avatar 504, the digital representation of the contact 506, and the virtual object 508 do not have to be presented within a predetermined distance of the HIPD 542. While an AR device 528 is described working with an HIPD, an MR headset can be interacted with in the same way as the AR device 528.

User inputs provided at the wrist-wearable device 526, the AR device 528, and/or the HIPD 542 are coordinated such that the user can use any device to initiate, continue, and/or complete an operation. For example, the user 502 can provide a user input to the AR device 528 to cause the AR device 528 to present the virtual object 508 and, while the virtual object 508 is presented by the AR device 528, the user 502 can provide one or more hand gestures via the wrist-wearable device 526 to interact and/or manipulate the virtual object 508. While an AR device 528 is described working with a wrist-wearable device 526, an MR headset can be interacted with in the same way as the AR device 528.

Integration of Artificial Intelligence with XR Systems

FIG. 5A illustrates an interaction in which an artificially intelligent virtual assistant can assist in requests made by a user 502. The AI virtual assistant can be used to complete open-ended requests made through natural language inputs by a user 502. For example, in FIG. 5A the user 502 makes an audible request 544 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 5A also illustrates an example neural network 552 used in Artificial Intelligence applications. Uses of Artificial Intelligence (AI) are varied and encompass many different aspects of the devices and systems described herein. AI capabilities cover a diverse range of applications and deepen interactions between the user 502 and user devices (e.g., the AR device 528, an MR device 532, the HIPD 542, the wrist-wearable device 526). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 502 can interact with an AI model through natural language inputs captured by a voice sensor, text inputs, or any other input modality that accepts natural language and/or a corresponding voice sensor module. In another instance, input is provided by tracking the eye gaze of a user 502 via a gaze tracker module. Additionally, the AI model can also receive inputs beyond those supplied by a user 502. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 528) or from multiple devices that are in communication with each other (e.g., a system that includes at least two of an AR device 528, an MR device 532, the HIPD 542, the wrist-wearable device 526, etc.). The AI model can also access additional information (e.g., one or more servers 530, the computers 540, the mobile devices 550, and/or other electronic devices) via a network 525.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 528, an MR device 532, the HIPD 542, the wrist-wearable device 526) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 528, an MR device 532, the HIPD 542, the wrist-wearable device 526), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 542), haptic feedback can provide information to the user 502. An AI model can also use the inputs described above to determine the appropriate modality and device(s) to present content to the user (e.g., a user walking on a busy road can be presented with an audio output instead of a visual output to avoid distracting the user 502).

### Example Augmented Reality Interaction

FIG. 5B shows the user 502 wearing the wrist-wearable device 526 and the AR device 528 and holding the HIPD 542. In the second AR system 500b, the wrist-wearable device 526, the AR device 528, and/or the HIPD 542 are used to receive and/or provide one or more messages to a contact of the user 502. In particular, the wrist-wearable device 526, the AR device 528, and/or the HIPD 542 detect and coordinate one or more user inputs to initiate a messaging application and prepare a response to a received message via the messaging application.

In some embodiments, the user 502 initiates, via a user input, an application on the wrist-wearable device 526, the AR device 528, and/or the HIPD 542 that causes the application to initiate on at least one device. For example, in the second AR system 500b the user 502 performs a hand gesture associated with a command for initiating a messaging application (represented by messaging user interface 512); the wrist-wearable device 526 detects the hand gesture; and, based on a determination that the user 502 is wearing the AR device 528, causes the AR device 528 to present a messaging user interface 512 of the messaging application. The AR device 528 can present the messaging user interface 512 to the user 502 via its display (e.g., as shown by user 502's field of view 510). In some embodiments, the application is initiated and can be run on the device (e.g., the wrist-wearable device 526, the AR device 528, and/or the HIPD 542) that detects the user input to initiate the application, and the device provides another device operational data to cause the presentation of the messaging application. For example, the wrist-wearable device 526 can detect the user input to initiate a messaging application, initiate and run the messaging application, and provide operational data to the AR device 528 and/or the HIPD 542 to cause presentation of the messaging application. Alternatively, the application can be initiated and run at a device other than the device that detected the user input. For example, the wrist-wearable device 526 can detect the hand gesture associated with initiating the messaging application and cause the HIPD 542 to run the messaging application and coordinate the presentation of the messaging application.

Further, the user 502 can provide a user input provided at the wrist-wearable device 526, the AR device 528, and/or the HIPD 542 to continue and/or complete an operation initiated at another device. For example, after initiating the messaging application via the wrist-wearable device 526 and while the AR device 528 presents the messaging user interface 512, the user 502 can provide an input at the HIPD 542 to prepare a response (e.g., shown by the swipe gesture performed on the HIPD 542). The user 502's gestures performed on the HIPD 542 can be provided and/or displayed on another device. For example, the user 502's swipe gestures performed on the HIPD 542 are displayed on a virtual keyboard of the messaging user interface 512 displayed by the AR device 528.

In some embodiments, the wrist-wearable device 526, the AR device 528, the HIPD 542, and/or other communicatively coupled devices can present one or more notifications to the user 502. The notification can be an indication of a new message, an incoming call, an application update, a status update, etc. The user 502 can select the notification via the wrist-wearable device 526, the AR device 528, or the HIPD 542 and cause presentation of an application or operation associated with the notification on at least one device. For example, the user 502 can receive a notification that a message was received at the wrist-wearable device 526, the AR device 528, the HIPD 542, and/or other communicatively coupled device and provide a user input at the wrist-wearable device 526, the AR device 528, and/or the HIPD 542 to review the notification, and the device detecting the user input can cause an application associated with the notification to be initiated and/or presented at the wrist-wearable device 526, the AR device 528, and/or the HIPD 542.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 528 can present to the user 502 game application data and the HIPD 542 can use a controller to provide inputs to the game. Similarly, the user 502 can use the wrist-wearable device 526 to initiate a camera of the AR device 528, and the user can use the wrist-wearable device 526, the AR device 528, and/or the HIPD 542 to manipulate the image capture (e.g., zoom in or out, apply filters) and capture image data.

While an AR device 528 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 5C-1 and 5C-2, the user 502 is shown wearing the wrist-wearable device 526 and an MR device 532 (e.g., a device capable of providing either an entirely VR experience or an MR experience that displays object(s) from a physical environment at a display of the device) and holding the HIPD 542. In the third AR system 500c, the wrist-wearable device 526, the MR device 532, and/or the HIPD 542 are used to interact within an MR environment, such as a VR game or other MR/VR application. While the MR device 532 presents a representation of a VR game (e.g., first MR game environment 520) to the user 502, the wrist-wearable device 526, the MR device 532, and/or the HIPD 542 detect and coordinate one or more user inputs to allow the user 502 to interact with the VR game.

In some embodiments, the user 502 can provide a user input via the wrist-wearable device 526, the MR device 532, and/or the HIPD 542 that causes an action in a corresponding MR environment. For example, the user 502 in the third MR system 500c (shown in FIG. 5C-1) raises the HIPD 542 to prepare for a swing in the first MR game environment 520. The MR device 532, responsive to the user 502 raising the HIPD 542, causes the MR representation of the user 522 to perform a similar action (e.g., raise a virtual object, such as a virtual sword 524). In some embodiments, each device uses respective sensor data and/or image data to detect the user input and provide an accurate representation of the user 502's motion. For example, image sensors (e.g., SLAM cameras or other cameras) of the HIPD 542 can be used to detect a position of the HIPD 542 relative to the user 502's body such that the virtual object can be positioned appropriately within the first MR game environment 520; sensor data from the wrist-wearable device 526 can be used to detect a velocity at which the user 502 raises the HIPD 542 such that the MR representation of the user 522 and the virtual sword 524 are synchronized with the user 502's movements; and image sensors of the MR device 532 can be used to represent the user 502's body, boundary conditions, or real-world objects within the first MR game environment 520.

In FIG. 5C-2, the user 502 performs a downward swing while holding the HIPD 542. The user 502's downward swing is detected by the wrist-wearable device 526, the MR device 532, and/or the HIPD 542 and a corresponding action is performed in the first MR game environment 520. In some embodiments, the data captured by each device is used to improve the user's experience within the MR environment. For example, sensor data of the wrist-wearable device 526 can be used to determine a speed and/or force at which the downward swing is performed and image sensors of the HIPD 542 and/or the MR device 532 can be used to determine a location of the swing and how it should be represented in the first MR game environment 520, which, in turn, can be used as inputs for the MR environment (e.g., game mechanics, which can use detected speed, force, locations, and/or aspects of the user 502's actions to classify a user's inputs (e.g., user performs a light strike, hard strike, critical strike, glancing strike, miss) or calculate an output (e.g., amount of damage)).

FIG. 5C-2 further illustrates that a portion of the physical environment is reconstructed and displayed at a display of the MR device 532 while the MR game environment 520 is being displayed. In this instance, a reconstruction of the physical environment 546 is displayed in place of a portion of the MR game environment 520 when object(s) in the physical environment are potentially in the path of the user (e.g., a collision with the user and an object in the physical environment are likely). Thus, this example MR game environment 520 includes (i) an immersive VR portion 548 (e.g., an environment that does not have a corollary counterpart in a nearby physical environment) and (ii) a reconstruction of the physical environment 546 (e.g., table 550 and cup 552). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 526, the MR device 532, and/or the HIPD 542 are described as detecting user inputs, in some embodiments, user inputs are detected at a single device (with the single device being responsible for distributing signals to the other devices for performing the user input). For example, the HIPD 542 can operate an application for generating the first MR game environment 520 and provide the MR device 532 with corresponding data for causing the presentation of the first MR game environment 520, as well as detect the user 502's movements (while holding the HIPD 542) to cause the performance of corresponding actions within the first MR game environment 520. Additionally or alternatively, in some embodiments, operational data (e.g., sensor data, image data, application data, device data, and/or other data) of one or more devices is provided to a single device (e.g., the HIPD 542) to process the operational data and cause respective devices to perform an action associated with processed operational data.

In some embodiments, the user 502 can wear a wrist-wearable device 526, wear an MR device 532, wear smart textile-based garments 538 (e.g., wearable haptic gloves), and/or hold an HIPD 542 device. In this embodiment, the wrist-wearable device 526, the MR device 532, and/or the smart textile-based garments 538 are used to interact within an MR environment (e.g., any AR or MR system described above in reference to FIGS. 5A-5B). While the MR device 532 presents a representation of an MR game (e.g., second MR game environment 520) to the user 502, the wrist-wearable device 526, the MR device 532, and/or the smart textile-based garments 538 detect and coordinate one or more user inputs to allow the user 502 to interact with the MR environment.

In some embodiments, the user 502 can provide a user input via the wrist-wearable device 526, an HIPD 542, the MR device 532, and/or the smart textile-based garments 538 that causes an action in a corresponding MR environment. In some embodiments, each device uses respective sensor data and/or image data to detect the user input and provide an accurate representation of the user 502's motion. While four different input devices are shown (e.g., a wrist-wearable device 526, an MR device 532, an HIPD 542, and a smart textile-based garment 538) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 538) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 538 can be used in conjunction with an MR device and/or an HIPD 542.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 5A-5C-2 provided above are intended to augment the description provided in reference to FIGS. 1A-4. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory computer readable storage medium including instructions that, when executed by a computing device, cause the computing device to:
in response to a first user input, initiate a recommended command workflow, wherein the recommended command workflow includes:
presenting, via a display communicatively coupled with the computing device, a first recommended command that is performed by one or more of the computing device and an application in communication with the computing device, wherein the first recommended command is one of a plurality of recommended commands determined based on one or more of user data and device data, and
in response to a second user input selecting the first recommended command:
causing performance of the first recommended command at one or more of the computing device and the application, and
presenting, via the display, a second recommended command that is performed by one or more of the computing device and the application, wherein the second recommended command i) is one of the plurality of recommended commands and ii) augments the first recommended command.

2. The non-transitory computer readable storage medium of claim 1, wherein the first recommended command and the second recommended command are associated with operations performed in sequential order.

3. The non-transitory computer readable storage medium of claim 1, wherein the first recommended command includes an aggregation of at least two operations.

4. The non-transitory computer readable storage medium of claim 1, wherein the instructions, when executed by the computing device, further cause the computing device to:
in response to a third user input disregarding the first recommended command, present, via the display, a third recommended command that is performed by one or more of the computing device and the application, wherein the third recommended command is:
one of the plurality of recommended commands, and
a continuation of the recommended command workflow.

5. The non-transitory computer readable storage medium of claim 4, wherein the first recommended command and the third recommended command are associated with operations performed in nonsequential order.

6. The non-transitory computer readable storage medium of claim 1, wherein the instructions, when executed by the computing device, further cause the computing device to:
in response to a fourth user input selecting the second recommended command:
causing performance of the second recommended command at one or more of the computing device and the application, and
in accordance with a determination that the second recommended command is an ending recommended command of the recommended command workflow, terminating the recommended command workflow.

7. The non-transitory computer readable storage medium of claim 1, wherein presenting, via the display, the first recommended command includes:
presenting a modification command, wherein the modification command, when selected, allows for the performance of one or more operations for editing a command of the plurality of recommended commands, removing a command of the plurality of recommended commands, and adding commands to the plurality of recommended commands.

8. An electronic device, comprising:
one or more displays; and
one or more programs, wherein the one or more programs are stored in memory and configured to be executed by one or more processors, the one or more programs including instructions for performing:
in response to a first user input, initiating a recommended command workflow, wherein the recommended command workflow includes:
presenting, via a display communicatively coupled with an electronic device, a first recommended command that is performed by one or more of the electronic device and an application in communication with the electronic device, wherein the first recommended command is one of a plurality of recommended commands determined based on one or more of user data and device data, and
in response to a second user input selecting the first recommended command:
causing performance of the first recommended command at one or more of the electronic device and the application, and
presenting, via the display, a second recommended command that is performed by one or more of the electronic device and the application, wherein the second recommended command i) is one of the plurality of recommended commands and ii) augments the first recommended command.

9. The electronic device of claim 8, wherein the first recommended command and the second recommended command are associated with operations performed in sequential order.

10. The electronic device of claim 8, wherein the first recommended command includes an aggregation of at least two operations.

11. The electronic device of claim 8, wherein the one or more programs, when executed by the one or more processors, further cause performance of:
in response to a third user input disregarding the first recommended command, presenting, via the display, a third recommended command that is performed by one or more of the electronic device and the application, wherein the third recommended command is:
one of the plurality of recommended commands, and
a continuation of the recommended command workflow.

12. The electronic device of claim 11, wherein the first recommended command and the third recommended command are associated with operations performed in nonsequential order.

13. The electronic device of claim 8, wherein the one or more programs, when executed by the one or more processors, further cause performance of:
in response to a fourth user input selecting the second recommended command:
causing performance of the second recommended command at one or more of the electronic device and the application, and
in accordance with a determination that the second recommended command is an ending recommended command of the recommended command workflow, terminating the recommended command workflow.

14. The electronic device of claim 8, wherein presenting, via the display, the first recommended command includes:
presenting a modification command, wherein the modification command, when selected, allows for the performance of one or more operations for editing a command of the plurality of recommended commands, removing a command of the plurality of recommended commands, and adding commands to the plurality of recommended commands.

15. A method, comprising:
in response to a first user input, initiating a recommended command workflow, wherein the recommended command workflow includes:
presenting, via a display communicatively coupled with a computing device, a first recommended command that is performed by one or more of the computing device and an application in communication with the computing device, wherein the first recommended command is one of a plurality of recommended commands determined based on one or more of user data and device data, and
in response to a second user input selecting the first recommended command:
causing performance of the first recommended command at one or more of the computing device and the application, and
presenting, via the display, a second recommended command that is performed by one or more of the computing device and the application, wherein the second recommended command i) is one of the plurality of recommended commands and ii) augments the first recommended command.

16. The method of claim 15, wherein the first recommended command and the second recommended command are associated with operations performed in sequential order.

17. The method of claim 15, wherein the first recommended command includes an aggregation of at least two operations.

18. The method of claim 15, further comprising:
in response to a third user input disregarding the first recommended command, presenting, via the display, a third recommended command that is performed by one or more of the computing device and the application, wherein the third recommended command is:
one of the plurality of recommended commands, and
a continuation of the recommended command workflow.

19. The method of claim 18, wherein the first recommended command and the third recommended command are associated with operations performed in nonsequential order.

20. The method of claim 15, further comprising:
in response to a fourth user input selecting the second recommended command:
causing performance of the second recommended command at one or more of the computing device and the application, and
in accordance with a determination that the second recommended command is an ending recommended command of the recommended command workflow, terminating the recommended command workflow.
